(19) United States
(12) Patent Application Publication
(10) Pub. No.: US 2026/0181010 A1
(43) Pub. Date: Jun. 25, 2026

(54) METHOD AND SYSTEM FOR TRANSFORMING SECURITY ADVISORIES INTO TARGETED MITIGATION STRATEGIES

(71) Applicant: Siemens Industry, Inc., Alpharetta, GA (US)

(72) Inventors: Charif Mahmoudi, Montclair, NJ (US); Gaurav Kumar Srivastava, Plainsboro, NJ (US)

(73) Assignee: Siemens Industry, Inc., Alpharetta, GA (US)

(21) Appl. No.: 18/991,991

(22) Filed: Dec. 23, 2024

(51) Int. Cl. H04L 9/40

(52) U.S. Cl. CPC H04L 63/1433; H04L 63/1441

(57) ABSTRACT

A computer-implemented method for transforming security advisories into targeted actionable mitigation strategies is provided. The method includes receiving a security advisory describing a vulnerability, processing the security advisory using a first language learning model (LLM) to extract vulnerability characteristics, generating an interaction model of sub-systems within a target system based on a topology of the target system, generating at least one actionable mitigation strategy for the vulnerability using a fine-tuned second LLM based on the extracted vulnerability characteristics and the interaction model, and outputting the actionable mitigation strategy as a security enhancement implementable on the target system. The method enables customized security enhancements for systems lacking official patches or manufacturer support.

### TECHNICAL FIELD

The present disclosure relates to cybersecurity, and more particularly to a method and system for transforming security advisories into targeted actionable mitigation strategies for systems lacking official patches or manufacturer support.

### BACKGROUND

In recent years, the field of cybersecurity has become increasingly complex and challenging as organizations face a growing number of sophisticated threats and vulnerabilities. One of the key components in managing cybersecurity risks is the effective handling of vulnerability information, such as security advisories or bulletins. These advisories provide information about known vulnerabilities in software and hardware systems, prompting organizations to take appropriate measures to protect their assets.

Vulnerability management platforms have emerged as essential tools for organizations to track and monitor potential security risks. These platforms can monitor vulnerabilities in an organization's assets and provide a centralized repository for security teams to assess and prioritize vulnerabilities affecting their systems. However, while these platforms can identify and catalog vulnerabilities, they often fall short in providing actionable strategies for mitigation, especially in cases where official patches or manufacturer-recommended solutions are unavailable.

The challenge of securing systems with known vulnerabilities but lacking official patches or recommended solutions from manufacturers presents a significant problem for many organizations. This situation is particularly prevalent in environments with legacy systems, specialized software, or mission-critical applications that cannot be easily updated or replaced. In such cases, security teams are left to devise their own mitigation strategies, often with limited information and resources.

Traditional approaches to vulnerability management often rely on generic rules or guidelines that may not adequately address the unique characteristics of specific target systems. This one-size-fits-all approach can lead to suboptimal security measures that fail to effectively mitigate risks or, in some cases, introduce operational issues.

The increasing complexity of modern IT infrastructures, which often include a mix of legacy systems, cloud-based services, and Internet of Things (IoT) devices, further complicates the task of translating general security advisories into targeted, actionable mitigation strategies. Organizations need more sophisticated methods to analyze vulnerabilities in the context of their specific system architectures and operational requirements.

### SUMMARY

Aspects of the present disclosure provide methods, systems, and computer program products that can address and overcome one or more of the above-described technical challenges. In particular, the present disclosure provides techniques for transforming security advisories into targeted actionable mitigation strategies, particularly for systems with known vulnerabilities lacking official patches or recommended solutions from manufacturers.

According to an aspect of the present disclosure, a computer-implemented method for transforming security advisories into targeted actionable mitigation strategies is provided. The method comprises receiving, as input, a security advisory describing a vulnerability. The method further comprises processing, using a first language learning model (LLM), the security advisory to extract vulnerability characteristics. The method also comprises generating, for a target system, an interaction model of sub-systems within the target system based on a topology of the target system. Additionally, the method comprises generating, using a fine-tuned second LLM, at least one actionable mitigation strategy for the vulnerability based on the extracted vulnerability characteristics and the interaction model. The method further comprises outputting the actionable mitigation strategy as a security enhancement implementable on the target system.

According to another aspect of the present disclosure, a computer program product including a non-transitory computer-readable medium storing instructions is provided. When executed by one or more processors, the instructions cause the one or more processors to perform the method described above.

According to yet another aspect of the present disclosure, a system for transforming security advisories into targeted actionable mitigation strategies is provided. The system includes one or more processors and memory storing software modules executable by the one or more processors. The software modules comprise a vulnerability characteristics extractor, an interaction model generator and a mitigation strategy composer. The vulnerability characteristics extractor is configured to receive as input a security advisory describing a vulnerability and process, using a first language learning model (LLM), the security advisory to extract vulnerability characteristics. The interaction model generator is configured to generate, for a target system, an interaction model of sub-systems within the target system based on a topology of the target system. The mitigation strategy composer configured is generate, using a fine-tuned second LLM, at least one actionable mitigation strategy for the vulnerability based on the extracted vulnerability characteristics and the interaction model, and output the actionable mitigation strategy as a security enhancement implementable on the target system.

Additional technical features and benefits may be realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The foregoing and other aspects of the present disclosure are best understood from the following detailed description when read in connection with the accompanying drawings. To easily identify the discussion of any element or act, the most significant digit or digits in a reference number refer to the figure number in which the element or act is first introduced.

FIG. 1 illustrates an example of a security notification interface for displaying a security vulnerability.

FIG. 2 is a block diagram illustrating a system for transforming security advisories into targeted actionable mitigation strategies according to one or more embodiments.

FIG. 3 shows an example of a computing system that can support transformation of security advisories into targeted actionable mitigation strategies according to disclosed embodiments.

### DETAILED DESCRIPTION

In today's interconnected digital landscape, organizations face significant challenges in securing their systems against known vulnerabilities, particularly when official patches or manufacturer support are unavailable. In many cases, organizations encounter vulnerabilities in their systems that are identified through security advisories or bulletins. The techniques described herein can transform security advisories into highly customized and relevant mitigation strategies by leveraging advanced language processing and machine learning techniques and interaction models of the target systems where the mitigation strategies are to be implemented. The target system can include, for example, a building automation system or a manufacturing or industrial environment, among others.

Unlike known solutions/products that often provide generic rules or guidelines, the disclosed techniques offer a high degree of customization. By processing the language of a security advisory using a first LLM, utilizing the target system's interaction model, and employing a fine-tuned second LLM, mitigation strategies may be generated that are tailored to the specific characteristics and vulnerabilities of the target system. By transforming security advisories into targeted actionable mitigation strategies, the disclosed techniques may enable organizations to respond more effectively to security threats, even when faced with limitations in official support or patch availability. This approach may contribute to improved overall system security and resilience in an evolving threat landscape.

The interaction model of the target system may be generated utilizing available topology information of the target system. In some embodiments, the interaction model of the target system may be generated by receiving topology information for the target system from a network monitoring tool or an asset inventory management tool or as a manual input, and transforming the system topology information into the interaction model using a rule-based heuristic algorithm. The disclosed techniques may thereby be agnostic to the type of target system. As a further feature, the interaction model may be dynamically updated, e.g., using the heuristic algorithm, with a detected change in the topology of the target system. In some cases, the change in topology of the target system may be automatically detected using a network monitoring tool or an asset inventory management tool.

The second LLM may be fine-tuned, for example, by training on a dataset comprising expert information on past mitigation actions for known vulnerabilities of the target system. In some embodiments, the second LLM may be fine-tuned (e.g., using the dataset) to determine the actionable mitigation strategy by prioritizing mitigation actions at higher levels of communication in the interaction model. The mitigation strategy can allow the target system to be protected while giving the security personnel time to apply the actual patches either once they are available or when there is a maintenance window to apply those patches without causing unplanned downtime. Furthermore, by focusing on higher-level communication components, such as network switches or firewalls, it may be possible to implement more comprehensive and efficient security measures that protect multiple sub-systems simultaneously.

The actionable mitigation strategy may comprise various types of security enhancements tailored to the target system. In some cases, the strategy may include specific patch installation recommendations, providing detailed guidance on which patches to apply and how to implement them effectively. Configuration adjustments may also be part of the mitigation strategy, allowing for changes in system settings or parameters to reduce vulnerability exposure without requiring extensive software updates. Additionally, the system may output additional security controls tailored to the target system, such as implementing access restrictions, enabling logging mechanisms, or deploying intrusion detection systems.

The actionable mitigation strategy thus defines a security enhancement implementable on the target system. The actionable mitigation strategy generated using the disclosed techniques may be implemented on the target system in various ways, for example by security personnel, or in an automated manner, or via combinations thereof.

Before undertaking the description of specific embodiments, some terms that have been used in the present description and claims are defined:
A “security advisory” may refer to a formal notification that provides information about a specific security vulnerability or threat. A security advisory may include details such as the nature of the vulnerability, affected hardware or software components, potential impacts, and may in some cases include a recommended action. A security advisory may be issued, for example, by software vendors, security researchers, an organization's internal platform for tracking and reporting vulnerabilities or by public databases, such as U.S. Government based repository National Vulnerabilities Database (NVD). A security advisory may be downloadable as a digital file in a defined format such as HTML, JSON, among others.

A “language learning model” (LLM) may refer to a type of artificial intelligence model or neural network designed to process, understand, and generate human-like text. Present-day LLMs typically include a type of neural network architecture called transformers, although aspects of the disclosure are not limited to a specific type of neural network architecture. An LLM may be capable of unsupervised learning on large datasets of text to learn patterns, context, and relationships between words and phrases. For example, in the case of transformers, this is achieved through a now well-known concept of self-attention. In some cases, an LLM may be used to process and extract meaningful information from unstructured text, such as security advisories, or to generate human-readable content based on input data.

A “fine-tuned” LLM may refer to an LLM that that has been configured to a specific task by fine-tuning the model parameters of a pre-trained LLM using input-output pairs from a domain-specific dataset.

A “target system” may refer to the specific IT/OT/IoT infrastructure for which the security advisory is relevant and for which mitigation strategies are being developed. A target system may comprise hardware and/or software components that include not just the components affected by the vulnerability as per the security advisory but also components that interact with or are affected or influenced by such components.

“Topology” may refer to the physical or logical arrangement of components within a target system. By way of example, topology may describe how software applications, control devices, switches and other network elements are connected to each other.

An “interaction model” may refer to a representation of how different components or sub-systems within a larger system (target system) communicate and interact with each other. An interaction model may describe specific behaviors, operations, dependencies and data flow between various hardware and software elements in a target system.

An “actionable mitigation strategy” may refer to a specific, implementable action or set of actions designed to address and reduce the risk associated with an identified security vulnerability on a target system.

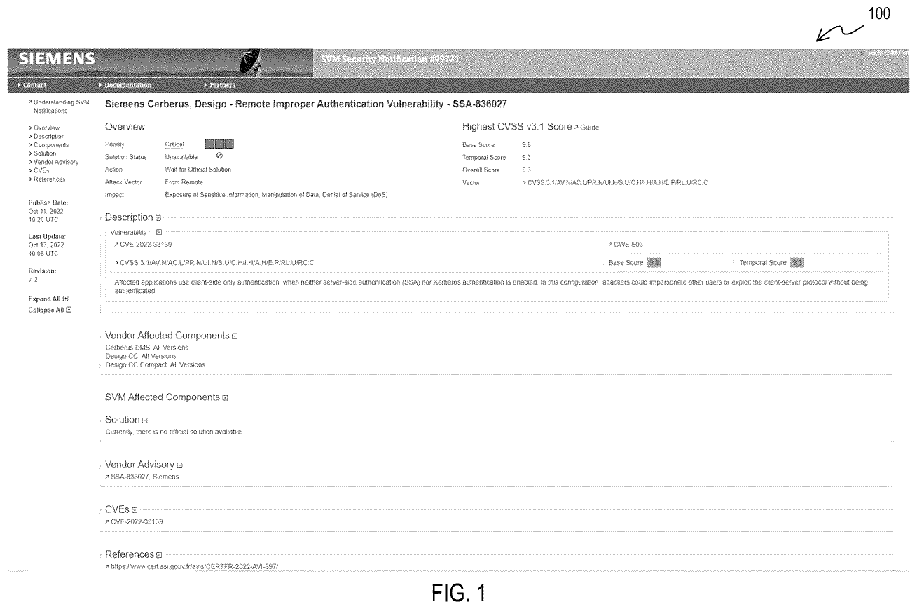

Turning now to the disclosed embodiments, FIG. 1 illustrates an example of a security notification interface 100 for displaying a security advisory describing a security vulnerability. In some embodiments, the security notification interface 100 may be provided by a vulnerability management platform that monitors or scans vulnerabilities in assets within an organization and reports detected vulnerabilities in security advisories or bulletins. The assets could include hardware and/or software, including products procured from third-party vendors that are used within the organization. In the illustrated example, the security notification interface 100 is provided by a vulnerability management platform of Siemens® (called Simens Vulnerability Management or SVM) showing a security advisory for a vulnerability affecting certain building automation products such as Cerberus DMS® and Desigo CC®.

As shown, the security advisory may include an overview of the vulnerability, a brief description of the vulnerability, affected components, and solution status. The vulnerability may be identified using an identifier, such as an identifier based on the Common Vulnerabilities and Exposures (CVE) system for referencing publicly known vulnerabilities. The security advisory may also provide details such as the vulnerability's Common Vulnerability Scoring System (CVSS) score, including base score, temporal score, and overall score. The security advisory may typically list the affected products and versions, as shown. In some cases, the description section of the security advisory may explain the nature of the vulnerability, which, by way of the present example, may relate to improper authentication in certain configurations. In the present example, the security advisory indicates that no official solution is currently available for the vulnerability.

The security notification interface 100 may serve as a means to communicate security information to system administrators or security personnel. By presenting detailed information about vulnerabilities in a structured format, the security notification interface 100 may enable organizations to quickly assess potential risks and prioritize their response efforts.

In many cases, as illustrated herein, security advisories may provide little or no recommendation on actionable mitigation strategies from the manufacturer of the affected asset(s). Sometimes, security advisories may include generic recommendations that are actionable, such as “update to latest version of software/firmware”. However, such recommendations are often not practical to implement, such as when the target system is critical and requires a high availability guarantee, i.e., low permissible downtime to install updates.

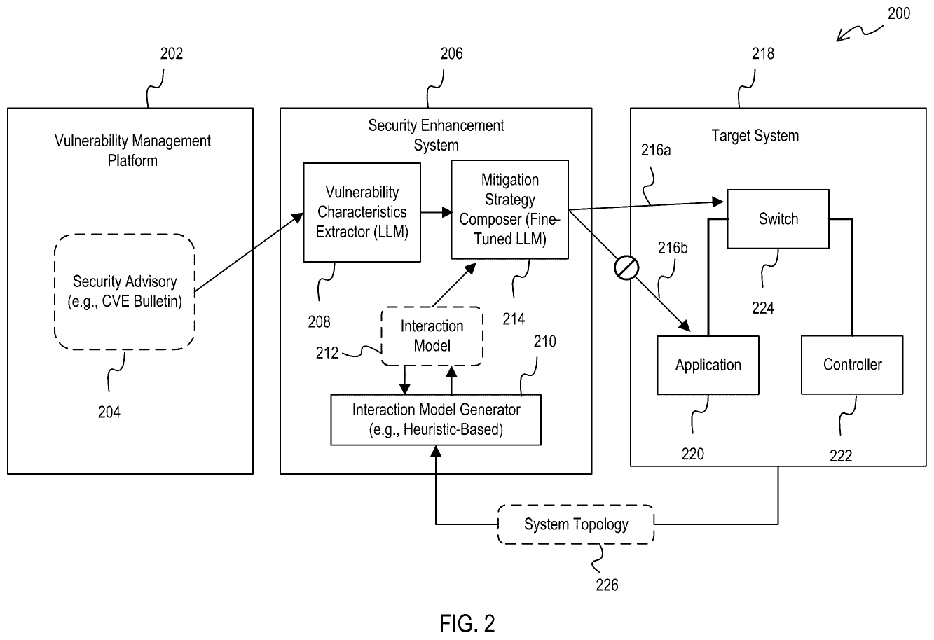

FIG. 2 illustrates an architecture of a system 200 for transforming security advisories into targeted actionable mitigation strategies according to one or more embodiments. As shown, the architecture of the system 200 may broadly comprise a structured data source for reporting known vulnerabilities, such as a vulnerability management platform 202, a security enhancement system 206, and a target system 218.

The vulnerability management platform 202 may be an internal platform of an organization, such as SVM, that can scan and report vulnerabilities in assets used within the organization. The vulnerability management platform 202 may periodically issue security advisories or bulletins, that can include a security advisory 204 describing a specific security vulnerability, such as illustrated in FIG. 1. For example, the security advisory 204 may include the vulnerability's CVE identifier, a description of the vulnerability, CVSS scores, affected components (e.g., products and their versions), solution status and recommendation actions, if any. In some embodiments, the security advisory 204 may be provided by other data sources, such as software vendors, security researchers, or public databases such as NVD, among others.

By way of example, the security advisory 204 may identify one of the components affected by the vulnerability to be a software application (or “application”) 220 within a target system 218. Continuing with the example, the description of the vulnerability may specify that a certain port (e.g., port #45) of the application 220 is vulnerable to be used by a malicious actor. The security advisory 204 may indicate that no official fixes are available or may generally recommend updating to the latest version of the application 220, if available.

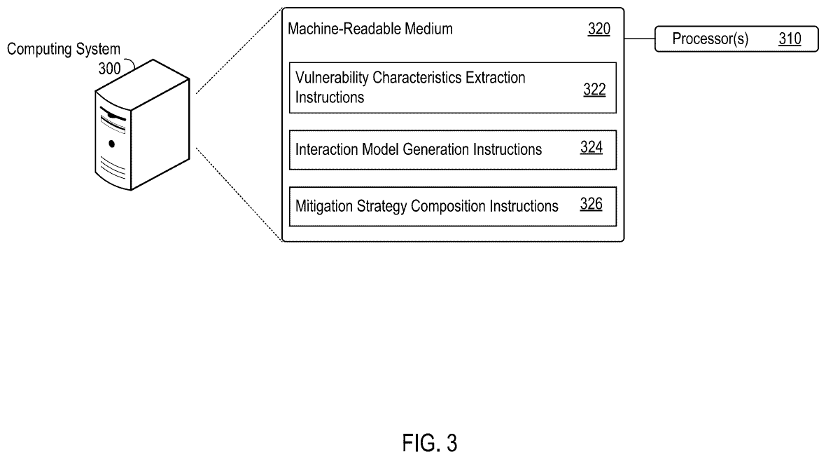

The security enhancement system 206 is defined by a number of components or modules, that can work to transform the security advisory 204 into at least one actionable mitigation strategy 216a customized for the target system 218. The various modules of the security enhancement system 206, including the vulnerability characteristics extractor 208, the interaction model generator 210 and the mitigation strategy composer 214, including components thereof, may be implemented by a computing system (for example, see FIG. 3) in various ways, for example, as hardware and programming. The programming for the modules 208, 210, 214 may take the form of processor-executable instructions stored on non-transitory machine-readable storage mediums and the hardware for the modules may include processors to execute those instructions. The processing capability of the systems, devices, and engines described herein, including the vulnerability characteristics extractor 208, the interaction model generator 210 and the mitigation strategy composer 214 may be distributed among multiple system components, such as among multiple processors and memories, optionally including multiple distributed processing systems or cloud/network elements.

In some cases, the security enhancement system 206 may be deployed as a software-as-a-service solution, offering flexibility and scalability for organizations of various sizes and industries. Alternatively, the security enhancement system 206 may be run locally, for example, on an edge device or other on-premises computing device, providing organizations with greater control over their security processes and data.

In the present example, the target system 218 is a building automation system. The target system 218 may include, in this case, the application 220, a switch 224, and a controller 222, that are operationally connected as shown. The application 220 may, for example, be a desktop application, such as a building management application. The switch 224 may be a network switch facilitating communication between components. The controller 222 may be a building automation controller. It should be noted that the shown target system architecture is simplified for illustrative purposes. For example, a building automation system may include several other components that interact with or are directly or indirectly influenced by the affected component (application 220) mentioned in the security advisory 204, such as sensors, actuators, or additional controllers, etc.

Aspects of the security enhancement system 206 are now described referring to the disclosed embodiments.

The security enhancement system 206 may include an input interface for receiving the security advisory 204 from the vulnerability management platform 202 or any other structured data source. A “structured data source” may refer to a repository or system that stores and organizes information in a predefined format or schema. For example, the input interface may be configured to make API calls to such a data source to download the security advisory 204 as a digital file in a structured format, such as HTML, JSON, among others. In some implementations, the input interface may be integrated into the vulnerability characteristics extractor 208. In some implementations, the vulnerability characteristics extractor 208 may utilize a file parsing module to read and preprocess the received digital file, extracting relevant text and metadata from the structured format.

The extracted text may then be fed into the first LLM of the vulnerability characteristics extractor 208. The first LLM may include, for example, a general purpose, off-the shelf model, which has been pre-trained on a large corpus of text with minimum or no fine-tuning. The first LLM may employ a transformer architecture. Non-limiting examples of an LLM suitable for this purpose include Llama 3.3, GPT-4, among others. In some embodiments, the transformer architecture may process the input text through several steps including tokenization, embedding, positional encoding, multi-head attention, feed-forward networks and layer normalization and residual connections. These steps are well-known to one skilled in the art and will not be described in any further detail. The first LLM may process the security advisory text through multiple layers of this architecture, gradually building a rich, contextual understanding of the content. In some implementations, the first LLM may use techniques such as transfer learning, where it has been pre-trained on a large corpus of text and fine-tuned on a smaller dataset of security-related documents. Additionally, or alternately, the first LLM may be customized using prompt engineering techniques to extract specified vulnerability characteristics from the security advisory 204.

As the first LLM processes the security advisory 204, it may identify and extract key vulnerability characteristics. These may include, but not limited to causes, potential attack vectors, and consequences. Causes refer to the underlying factors or conditions that give rise to the vulnerability. This could include software bugs, design flaws, or misconfigurations that create security weaknesses. By identifying the causes, the security enhancement system 206 can better understand the nature of the vulnerability and potentially suggest more targeted mitigation strategies. Potential attack vectors describe the various methods or pathways that an attacker might exploit to take advantage of the vulnerability. This could include specific input methods, network protocols, or system interfaces that could be manipulated. Understanding the potential attack vectors is crucial for developing effective mitigation strategies that address all possible avenues of exploitation. Consequences outline the potential impacts or outcomes if the vulnerability were to be successfully exploited. This could range from unauthorized access to sensitive data, system crashes, or even complete system compromise. By extracting information about the consequences, the system can assess the severity of the vulnerability and prioritize mitigation efforts accordingly. In some embodiments, the LLM may also be configured to extract additional vulnerability characteristics, such as severity and impact assessment, temporal information (e.g., date of discovery, patch availability, etc.), among others.

The first LLM thus goes beyond simple keyword matching or rule-based analysis. The output of the first LLM may be an enriched description of the vulnerability, structured in a way that facilitates further processing and analysis. This enriched description may include not only the explicitly stated information from the original security advisory 204 but also inferred or derived information based on the LLM's understanding of security vulnerabilities in general. In some implementations, the vulnerability characteristics extractor 208 may employ additional post-processing steps to refine and structure the output from the LLM. This may include, for example, the application of domain-specific rules to standardize the extracted information.

The interaction model generator 210 creates an interaction model 212 of components or sub-systems within the target system 218 based on the target system's topology. In embodiments, as described herein, the interaction model generator 210 may receive topology information for the target system 218 (system topology 226) utilizing automated tools, or via a manual input, and map the system topology 226 to the interaction model 212 using pre-defined rules. In some implementations, the system topology 226 may be received via a network monitoring tool. An example of a network monitoring tool is a networking mapping tool (such as Nmap®), that can scan a network to discover hosts, their IP addresses, services, and open ports on a network. Another example is a network analytical tool (such as Netstat®), that can report active network connections, routing tables, and interface statistics. In some embodiments, the system topology 226 may be also obtained via an asset inventory management tool (such as asset management platforms provided by Nozomi®, Dragos®, OT Base®, SINEC Security®, among others), that can automatically discover and inventory OT devices and provide detailed network topology diagrams to help visualize and manage OT networks.

The interaction model generator 210 may transform the system topology 226 information into the interaction model 212 using a rule-based heuristic algorithm. The transformation process may involve applying a set of predefined rules to interpret and organize the raw topology data into a structured representation of how components within the target system 218 interact. The rule-based heuristic algorithm may analyze various aspects of the topology information, such as network connections, data flows, and dependencies between components, to create a comprehensive interaction model. For example, if the target system is a web application, the interaction model 212 would capture the flow of data, user interactions, and communication with external systems. This understanding allows the security enhancement system 206 to identify the specific areas of the system that are affected by the vulnerabilities and determine the potential impact on overall system security.

To illustrate, if the system topology 226 obtained via a network monitoring tool indicates that two components or sub-systems are connected via a specific network protocol, the heuristic algorithm may create a corresponding relationship in the interaction model. Similarly, if the topology data shows that one component sends data to another, this data flow would be represented in the interaction model. The algorithm may also infer higher-level interactions based on patterns in the topology data, such as identifying clusters of closely connected components that may represent functional sub-systems within the target system 218.

By using a rule-based approach, the interaction model generator 210 can consistently and efficiently process complex topology information, ensuring that the resulting interaction model 212 accurately reflects the structure and behavior of the target system while being agnostic to the type of target system 218. The interaction model 212 serves as an input for the mitigation strategy composer 214, enabling it to generate targeted and effective security enhancements that take into account the specific architecture and interdependencies of the target system 218.

In some embodiments, the interaction model 212 may be dynamically updated with any change in the topology of the target system 218. Such a change may be automatically detected or discovered by a network monitoring tool and asset inventory management tool, as described above. The dynamic updating of the interaction model 212 in response to changes in the target system's topology may represent an added feature of the security enhancement system 206. This capability ensures that the interaction model 212 remains an accurate and up-to-date representation of the target system's structure and behavior, even as the system evolves over time.

For instance, if new components are added to the target system 218, such as additional controllers or sensors in a building automation system, the interaction model generator 210 would detect these changes and automatically incorporate them into the interaction model 212. Similarly, if existing components are removed or their connections are modified, these changes would be reflected in the updated interaction model. This dynamic updating process may involve periodic scanning of the target system's topology, real-time monitoring of system changes, or integration with change management systems. By maintaining an accurate interaction model, the security enhancement system 206 can consistently generate relevant and effective mitigation strategies that align with the current state of the target system 218.

The ability to dynamically update the interaction model is particularly valuable in complex and evolving environments, such as large-scale industrial systems or rapidly changing IT infrastructures. It ensures that the mitigation strategies generated by the mitigation strategy composer 214 remain applicable and effective, even as the target system 218 undergoes modifications or expansions.

The mitigation strategy composer 214 takes into account the enriched vulnerability description from the vulnerability characteristics extractor 208 along with the interaction model 212 to generate an actionable mitigation strategy 216a tailored for the target system 318. For this purpose, the mitigation strategy composer 214 employs a second fine-tuned LLM. The second LLM can have a similar architecture to the first LLM (e.g., transformer) and may be similarly pre-trained on a large corpus of text. In a next step, the pre-trained second LLM may undergo a specialized fine-tuning process to enhance its ability to generate effective and relevant mitigation strategies for the target system 218. The second LLM may be fine-tuned by training on a dataset comprising expert information on past mitigation actions for known vulnerabilities of the target system (e.g., in a supervised learning process). The dataset may be curated to encompass a wealth of expert knowledge and real-world experience in addressing security vulnerabilities relevant to the target system 218 including any sub-systems thereof.

The dataset used for the fine-tuning may comprise detailed information on past mitigation actions that have been successfully implemented for known vulnerabilities. This historical data can provide the second LLM with valuable insights into effective security practices, common pitfalls, and innovative solutions that have been developed over time. By learning from these past experiences, the second LLM can generate more informed and practical mitigation strategies tailored to the specific vulnerabilities and target systems it encounters.

Furthermore, the dataset can incorporate defensive strategies outlined in playbooks from various organizations. These playbooks, often developed by cybersecurity experts and industry leaders, offer comprehensive guidelines and best practices for responding to different types of security threats. By including this information in the training dataset, the second LLM can gain access to a diverse range of approaches and methodologies for addressing vulnerabilities across different contexts and industries. The inclusion of playbook strategies in the training data ensures that the second LLM's output strategies align with established industry standards and best practices. This approach helps to generate mitigation strategies that are not only effective but also compliant with recognized security frameworks and guidelines.

The mitigation strategy composer 214 may output a mitigation strategy 216a as a security enhancement implementable on the target system 218. In some embodiments, as illustrated here, the dataset for fine-tuning the second LLM may be carefully curated such that the mitigation strategy composer 214 prioritizes mitigation actions at higher levels of communication in the interaction model 212. In the example introduced earlier, where the security advisory 204 indicates a vulnerability where a specified port (e.g., port #45) on the application 220 may be used by a malicious actor, a potential mitigation strategy output 216a may involve implementing a fix on the switch 224 rather than installing a patch on the application 220 (shown by mitigation strategy 216b).

In the present example, by implementing a fix on the switch 224 rather than directly on the vulnerable application 220, the system can achieve several benefits. For example, addressing the vulnerability at the network switch level can potentially protect multiple applications or devices that communicate through that switch, not just the specific vulnerable application. Furthermore, implementing changes at the switch level often requires less downtime and poses fewer risks to the stability of critical applications compared to modifying the applications themselves. Also, centralized fixes at higher levels of the network architecture can be easier to manage, monitor, and update compared to distributed fixes across multiple applications. Also, network-level changes can often be implemented more quickly than application-level patches, especially in environments with strict change management processes. Still further, by avoiding direct modifications to the application, this approach can reduce the risk of introducing compatibility issues or unintended side effects in the application's functionality.

The described mitigation strategy may align with the principle of defense-in-depth, where multiple layers of security controls are implemented to provide comprehensive protection. By leveraging the interaction model 212, the mitigation strategy composer 214 can identify these opportunities for higher-level fixes that may not be immediately apparent from the security advisory 204 alone. This approach demonstrates the system's ability to generate sophisticated, context-aware mitigation strategies that go beyond simple patch recommendations.

In some cases, the mitigation strategy composer 214 may output specific patch installations as part of the output mitigation strategy. This may involve identifying and suggesting particular software updates or security patches that address the identified vulnerability. The output strategy may provide detailed instructions on how to obtain, verify, and apply these patches to the affected components of the target system.

Configuration adjustments may be another component of the actionable mitigation strategy. In some cases, the mitigation strategy composer 214 may output changes to system settings, network configurations, or application parameters that can mitigate the risk posed by the vulnerability without necessarily requiring software updates. These adjustments may include modifying access controls, changing default settings, or reconfiguring network protocols to reduce the attack surface.

The mitigation strategy composer 214 may also output additional security controls tailored to the target system as part of the mitigation strategy. These controls may encompass a wide range of security measures, such as implementing new firewall rules, deploying intrusion detection systems, or enhancing logging and monitoring capabilities. In some instances, the mitigation strategy composer 214 may output compensating controls that provide protection against the vulnerability when direct patching or configuration changes are not feasible.

The flexibility to include various types of mitigation actions allows the proposed security enhancement system 206 to generate comprehensive and adaptable strategies. For example, in cases where immediate patching is not possible due to operational constraints, the system may prioritize configuration adjustments and additional security controls as interim measures. In some implementations, the mitigation strategy composer 214 may combine multiple elements in its mitigation strategy. For instance, it may output a specific patch installation along with configuration adjustments to provide a more robust defense against the identified vulnerability.

The tailoring of these strategies to the target system 218 is one of the key aspects of the disclosed techniques. By leveraging the interaction model and understanding the specific architecture and constraints of the target system, the mitigation strategies can be customized to ensure they are both effective and feasible to implement within the given environment. This approach can allow organizations to address vulnerabilities in a manner that aligns with their specific operational requirements, risk tolerance, and technical capabilities. It provides a more nuanced and practical approach to vulnerability management compared to generic, one-size-fits-all recommendations.

The actionable mitigation strategy generated by the mitigation strategy composer 214 may be implemented on the target system 218 in various ways. In some cases, security personnel may manually implement the strategy by following the detailed instructions provided in the mitigation strategy output. This may include applying patches, adjusting configurations, or deploying additional security controls as recommended. Alternatively, the implementation process may be automated, leveraging existing IT management and automation tools to deploy the recommended changes across the target system 218. Automation may be used, for example, in large-scale systems or when rapid response is critical. In some implementations, the security enhancement system may integrate with existing IT service management platforms, allowing for seamless ticket creation and workflow management for implementing the mitigation strategies.

FIG. 3 shows an example of a computing system 300 that can support that can support transformation of security advisories into targeted actionable mitigation strategies according to disclosed embodiments. The computing system 300 includes at least one processor 310, which may take the form of a single or multiple processors. The processor(s) 310 may include a central processing unit (CPU), a graphics processing unit (GPU), a neural processing unit (NPU), a microprocessor, or any hardware device suitable for executing instructions stored on a memory comprising a machine-readable medium. The computing system 300 further includes a machine-readable medium 320. The machine-readable medium 320 may take the form of any non-transitory electronic, magnetic, optical, or other physical storage device that stores executable instructions, such as vulnerability characteristics extraction instructions 322, interaction model generation instructions 324 and mitigation strategy composition instructions 326, as shown in FIG. 3. As such, the machine-readable medium 320 may be, for example, Random Access Memory (RAM) such as a dynamic RAM (DRAM), flash memory, spin-transfer torque memory, an Electrically-Erasable Programmable Read-Only Memory (EEPROM), a storage drive, an optical disk, and the like.

The computing system 300 may execute instructions stored on the machine-readable medium 320 through the processor(s) 310. Executing the instructions (e.g., the vulnerability characteristics extraction instructions 322, the interaction model generation instructions 324 and the mitigation strategy composition instructions 326) may cause the computing system 300 to perform any of the technical features described herein, including according to any of the features of the vulnerability characteristics extractor 208, the interaction model generator 210 and the mitigation strategy composer 214 described above.

The systems, methods, devices, and logic described above, including the vulnerability characteristics extractor 208, the interaction model generator 210 and the mitigation strategy composer 214 modules, may be implemented in many different ways in many different combinations of hardware, logic, circuitry, and executable instructions stored on a machine-readable medium. For example, these modules may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine-readable instructions stored on the medium, which when executed in an endpoint, computer system, or other device, cause the device to perform operations according to any of the description above, including according to any features of the vulnerability characteristics extractor 208, the interaction model generator 210 and the mitigation strategy composer 214. Computer readable program instructions described herein can be downloaded to respective computing/processing devices from a computer readable storage medium or to an external computer or external storage device via a network, for example, the Internet, a local area network, a wide area network and/or a wireless network.

The processing capability of the systems, devices, and modules described herein, including the vulnerability characteristics extractor 208, the interaction model generator 210 and the mitigation strategy composer 214, may be distributed among multiple system components, such as among multiple processors and memories, optionally including multiple distributed processing systems or cloud/network elements. Parameters, databases, and other data structures may be separately stored and managed, may be incorporated into a single memory or database, may be logically and physically organized in many different ways, and may be implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

Although this disclosure has been described with reference to particular embodiments, it is to be understood that the embodiments and variations shown and described herein are for illustration purposes only. Modifications to the current design may be implemented by those skilled in the art, without departing from the scope of the patent claims.

1. A computer-implemented method for transforming security advisories into targeted actionable mitigation strategies, comprising:
receiving, as input, a security advisory describing a vulnerability;
processing, using a first language learning model (LLM), the security advisory to extract vulnerability characteristics;
generating, for a target system, an interaction model of sub-systems within the target system based on a topology of the target system;
generating, using a fine-tuned second LLM, at least one actionable mitigation strategy for the vulnerability based on the extracted vulnerability characteristics and the interaction model; and
outputting the actionable mitigation strategy as a security enhancement implementable on the target system.

2. The method according to claim 1, wherein receiving the security advisory comprises downloading a digital file containing the security advisory from a structured data source reporting known vulnerabilities.

3. The method according to claim 1, wherein the first LLM is prompted or trained to extract the vulnerability characteristics including causes, potential attack vectors, and consequences.

4. The method according to claim 1, wherein generating the interaction model comprises:
receiving topology information for the target system from a network monitoring tool or an asset inventory management tool or based on a manual input; and
transforming the system topology information into the interaction model using a rule-based heuristic algorithm.

5. The method according to claim 1, comprising detecting a change in the topology of the target system and dynamically updating the interaction model with the detected change in the topology of the target system.

6. The method according to claim 1, wherein the second LLM is fine-tuned by training on a dataset comprising expert information on past mitigation actions for known vulnerabilities of the target system.

7. The method according to claim 1, wherein the second LLM is fine-tuned to determine the at least one actionable mitigation strategy by prioritizing mitigation actions at higher levels of communication in the interaction model.

8. The method according to claim 1, wherein the at least one actionable mitigation strategy comprises at least one of: specific patch installation, configuration adjustments, or additional security controls tailored to the target system.

9. A non-transitory computer-readable storage medium storing instructions that, when executed by a processor, cause the processor to perform a method according to claim 1.

10. A system for transforming security advisories into targeted actionable mitigation strategies, comprising:
one or more processors; and
memory storing software modules executable by the one or more processors, the software modules comprising:
a vulnerability characteristics extractor configured to receive as input a security advisory describing a vulnerability and process, using a first language learning model (LLM), the security advisory to extract vulnerability characteristics;
an interaction model generator configured to generate, for a target system, an interaction model of sub-systems within the target system based on a topology of the target system; and
a mitigation strategy composer configured to generate, using a fine-tuned second LLM, at least one actionable mitigation strategy for the vulnerability based on the extracted vulnerability characteristics and the interaction model, and output the actionable mitigation strategy as a security enhancement implementable on the target system.

11. The system according to claim 10, wherein the software modules comprise an input interface configured to download a digital file containing the security advisory from a structured data source reporting known vulnerabilities.

12. The system according to claim 10, wherein the first LLM is prompted or trained to extract the vulnerability characteristics including causes, potential attack vectors, and consequences.

13. The system according to claim 10, wherein the interaction model generator is configured to:
receive topology information for the target system from a network monitoring tool or an asset inventory management tool or based on a manual input; and
transform the system topology information into the interaction model using a rule-based heuristic algorithm.

14. The system according to claim 10, wherein the interaction model generator is configured to dynamically update the interaction model with a detected change in the topology of the target system.

15. The system according to claim 10, wherein the second LLM is fine-tuned by training on a dataset comprising expert information on past mitigation actions for known vulnerabilities of the target system.

16. The system according to claim 10, wherein the second LLM is fine-tuned to determine the at least one actionable mitigation strategy by prioritizing mitigation actions at higher levels of communication in the interaction model.

17. The system according to claim 10, wherein the at least one actionable mitigation strategy comprises at least one of: specific patch installation, configuration adjustments, or additional security controls tailored to the target system.
